(19) United States
(12) Patent Application Publication
(10) Pub. No.: US 2006/0057280 A1
(43) Pub. Date: Mar. 16, 2006

(54) Method for producing a circuit

(76) Inventors: Walter Roethlingshoefer, Reutlingen (DE); Josef Weber, Oberriexingen (DE); Klaus Krueger, Hamburg (DE)

Correspondence Address: KENYON & KENYON LLP, ONE BROADWAY, NEW YORK, NY, 10004, US

(21) Appl. No.: 11/225,707

(22) Filed: Sep. 12, 2005

(30) Foreign Application Priority Data
Sep. 13, 2004 (DE) 102004044144.8

(51) Int. Cl. B05D 5/12

(52) U.S. Cl. 427/96.1

(57) ABSTRACT

A method for producing a printed circuit, including at least the following steps: feeding different colloid inks to different printing nozzles of at least one print head, the colloid inks each containing a printing carrier and particles of a basic substance; printing individual droplets of the different colloid inks onto a substrate surface of a substrate between printed circuit traces in such a way that the droplets intermix to form a resistance layer; and baking the substrate having the printed circuit traces and the imprinted resistance layer in such a way that the printing carrier is at least substantially removed. The resistors can therefore be printed quickly, advantageously in one run of the print head. A suitable square resistance value can be set for each resistor by appropriate dosing of the individual colloid inks, so that the surface requirement on the substrate is small.

### FIELD OF THE INVENTION

The present invention relates to a method for producing a circuit on a substrate.

### BACKGROUND INFORMATION

Using thick-film technology, resistors are applied in thin layers by screen-printing processes. The thicknesses of the fired layers are 10 to 15 μm, for example. The resistance layers are typically made of a glass/ruthenium oxide (RuO2) mixture, and are linked to printed circuit traces on the substrate. The mixture is laced with an organic printing carrier, e.g. a solvent or ethyl cellulose, to produce the necessary screen-printing capability.

Different resistance decades can be adjusted by way of the glass/ruthenium oxide ratio. Thus, for example, pastes having square resistances of 10 ohm, 100 ohm, 1 kOhm 10 kOhm, 100 kOhm and 1000 kOhm are used. The resistance value is preproduced via the length/width ratio with a tolerance of +/−50%, and subsequently exactly trimmed by a laser beam to a setpoint value with an exactitude of +/−0.5%. Up to six different printing planes are necessary, depending on the resistance value.

Since the precise resistance value is set by the geometric layout, surface requirement is generally large. It may be that when using several pastes, the surface requirement can be kept smaller; however, in the screen-printing process, the various pastes must be applied in several successive printing steps with drying in the interim. Production is therefore costly and time-consuming.

### SUMMARY OF THE INVENTION

The method of the present invention offers several advantages. According to the present invention, the resistance pastes are applied via a print head having a plurality of printing nozzles, i.e., according to the principle of an ink jet printer in the color printing process. Different colloid inks are dosed in fine droplets via the printing nozzles, advantageously piezoelectric nozzles; the resistance value can be set very precisely via an in situ mixture. In so doing, the specific resistance value can be ascertained theoretically in advance, or determined and set with the aid of a test sample and test firing. Therefore, according to the present invention, using a predefined number, e.g., three, different colloid inks, it is possible to set a large multitude of different resistance values. Consequently, it is not necessary to use and implement several decades of different resistance values as in the related art. The circuit of the present invention can be designed with more effective use of the surface, i.e. in a more space-saving manner, since not only separate resistance decades, but also any resistance values as needed may be set.

In the colloid inks, basic substances are finely dispersed in an organic printing carrier, e.g., wax. In this context, the colloid inks may be liquid, pasty or in principle even solid; in each case, they are fed from separate containers via a heating device to the print head, so that the colloid inks are finely dosed as low-viscosity substance via the piezoelectric nozzles within a sufficient period of time, and intermix on the substrate before the mixture solidifies. Sedimentation or separation of the basic-substance particles or pigments is thereby avoided.

The resistors are advantageously imprinted in a single run of the print head, thus eliminating the need for repeated printing and drying of the layers. This results in very short cycle times. The subsequent trimming is eliminated at least for the majority of resistors, advantageously in the case of all resistors.

To form very thick resistors, in principle, a plurality of layers may also be applied. According to the present invention, further elements of the circuit, particularly printed circuit traces, possibly also capacitors, may be printed using the print head, as well. The printed circuit traces are advantageously printed in a first run and dried before the subsequent run of the print head in which the resistors and possibly also capacitors are printed. The resistors may be sealed in the upward direction in a generally known manner by a cover layer made of glass before the circuit is baked or sintered.

### BRIEF DESCRIPTION OF THE DRAWINGS

FIG. 1 shows a cross-section through a resistor.

FIG. 2 shows a top view of the resistor according to FIG. 1.

FIG. 3 shows an intermediate step in the production of the resistor.

FIG. 4 shows a device of the present invention for printing the resistors.

### DETAILED DESCRIPTION

A device 1 of the present invention has a—in particular ceramic—substrate 2, on which a circuit 3 having printed circuit traces 4, 5 and a plurality of components, among them resistors 6, is imprinted.

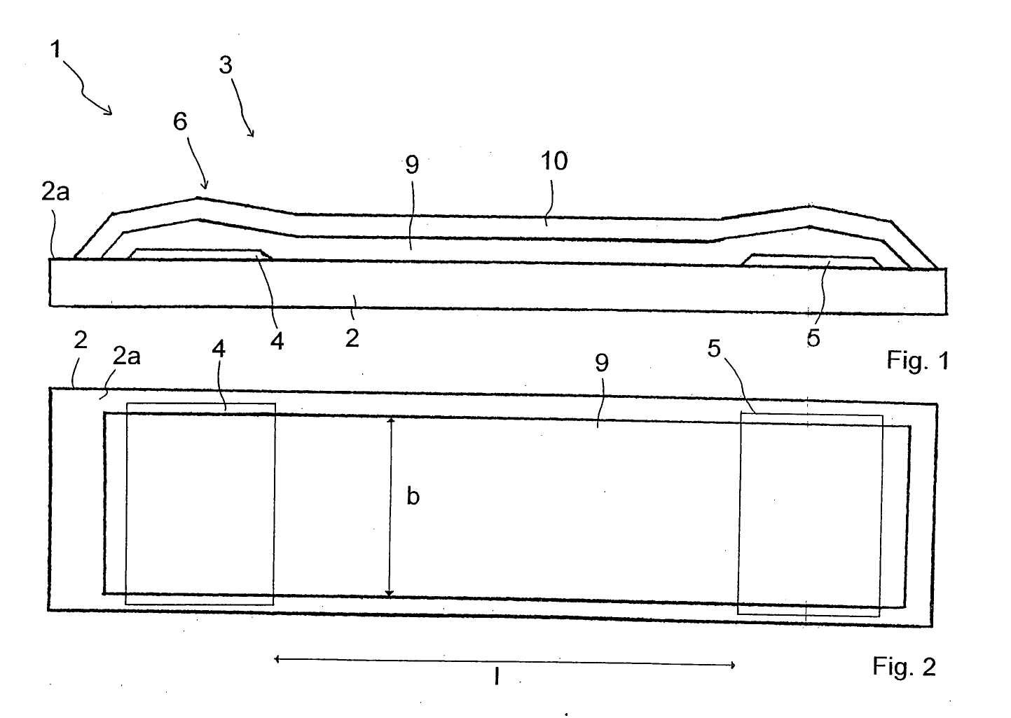

Ohmic resistor 6 shown in FIG. 1, 2, in a manner known per se, has a resistance layer 9 made, for example, of a ruthenium oxide/glass mixture, which is imprinted on substrate surface 2a of substrate 2 and partially covers regions of printed circuit traces 4, 5. A cover layer 10 made of a glass, e.g., a borosilicate glass, is applied on resistance layer 9. The ohmic resistance value of resistor 6 results as a function of the length l between printed circuit traces 4, 5, the lateral width b and a square resistance R_{W} as R=R_{W}*l/b.

To produce resistor 6, a printing device 12, shown schematically in FIG. 4, is used. Among other things, it has a print head 14 having piezoelectric nozzles 15, a heating device 16 connected upstream of print head 14, and three colloid ink containers 17. Accommodated in colloid ink containers 17 are different colloid inks 18.1, 18.2 and 18.3, each containing a printing carrier, e.g., a resin, and particles of a basic substance. In this context, basic substances may be various mixtures of ruthenium oxide and glass; additionally, for instance, colloid ink 18.3 may also contain metallic particles, e.g., silver, with which printed circuit traces 4, 5 are imprinted. In principle, colloid inks 18.1, 18.2 and 18.3 may be liquid, pasty or even solid; they become fluid by heating in heating device 16, so that they are printed onto substrate surface 2a as fine droplets 22 via piezoelectric nozzles 15, each of which is assigned to one colloid ink. In so doing, print head 14—as basically known when working with piezoelectric printers—moves parallel to surface 2a and screens the region to be printed on.

According to the present invention, only resistors 6, or also other components, particularly printed circuit traces 4 and 5 as well as, for example, capacitors may be printed with the aid of print head 14 and using the various colloid inks. In each case a specific mixture of available colloid inks 18.1, 18.2, 18.3 is adjusted for each element 4, 5, 6; as an alternative to the specific embodiment shown, if desired, more than three colloid inks may be fed to print head 14 via corresponding lines 20. According to the present invention, different resistors 6 may be printed with different colloid ink mixtures, i.e., different R_{W}.

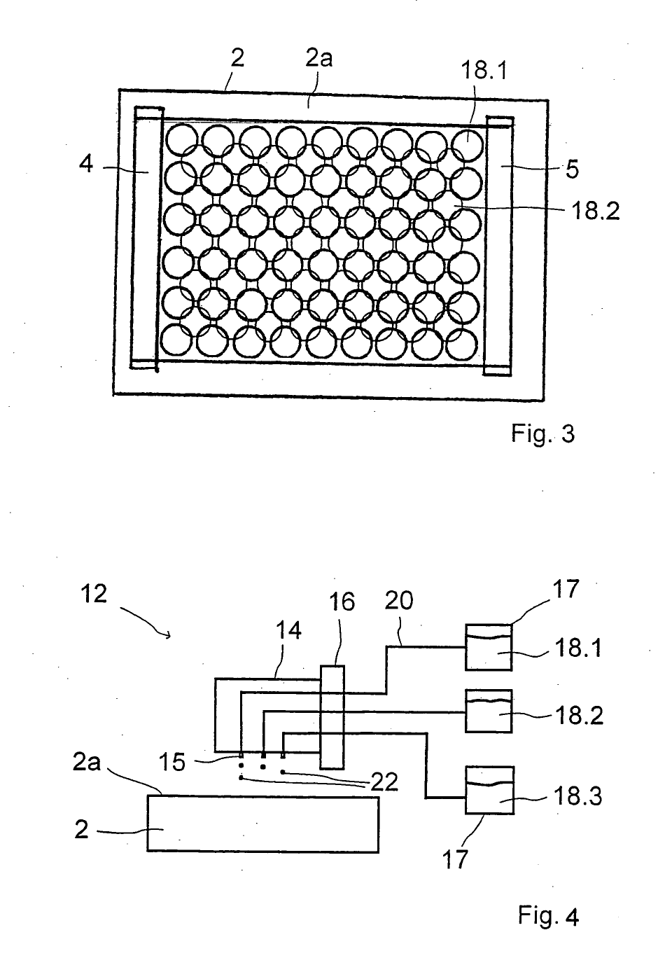

According to FIG. 3, first of all, printed circuit traces 4 and 5 are imprinted on substrate surface 2a, e.g., by a screen-printing process or using print head 14. After the paste of printed circuit traces 4 and 5 has dried, the different colloid inks—only two colloid inks 18.1 and 18.2 are shown in FIG. 3 for the sake of simplicity—are imprinted in screened fashion, as is basically known when working with color printers. In so doing, individual droplets 22 output by piezoelectric nozzles 15 mix on substrate surface 2a; the applied mixture subsequently dries and hardens. Cover layer 10 is subsequently imprinted, for example, by a screen-printing process or also with the aid of print head 14.

The entire device 1 is subsequently fired in an oven so that the organic printing carrier vaporizes or burns and the circuit shown in FIG. 1, 2 results.

Square resistance values within a large range from, e.g., 10 ohm to 1 MOhm may be attained by suitable selection of colloid inks 18.1, 18.2 and 18.3. It is not necessary to subsequently additionally trim printed resistors 6 using a laser beam; if applicable, a few very fine structures may be trimmed by a laser beam. To set the mixture ratio of ruthenium oxide and glass very precisely, different mixture ratios may already be used in particular as colloid inks. Since, for example, a mixture having 50% ruthenium oxide exhibits a square resistance of 10 ohm, and a mixture having 15% ruthenium oxide already exhibits a square resistance of 10 MOhm, three colloid inks 18.1, 18.2, 18.3 having a different ruthenium oxide content, e.g., 50%, 30% and 15%, may be used to permit precise adjustment of the intermediate values. Additionally, the inks may also contain platinum oxide (PtO), for example. If printed circuit traces 4, 5 are printed from silver via print head 14, the silver may also be used when printing resistor 6.

What is claimed is:

1. A method for producing a printed circuit, comprising:
feeding different colloid inks to different printing nozzles of at least one print head, the colloid inks each containing a printing carrier and particles of a basic substance;
printing individual droplets of the different colloid inks onto a substrate surface of a substrate between printed circuit traces in such a way that the droplets intermix to form an imprinted resistance layer; and
baking the substrate having the printed circuit traces and the imprinted resistance layer in such a way that the printing carrier is at least substantially removed.

2. The method according to claim 1, wherein the basic substances of the colloid inks exhibit different square resistance values.

3. The method according to claim 1, wherein the basic substances of the colloid inks have different mixture ratios of various resistance materials, including at least one of ruthenium oxide and glass.

4. The method according to claim 1, further comprising printing a plurality of resistors using the same print head, different square resistance values of the plurality of resistors being set by different mixture ratios of the colloid inks.

5. The method according to claim 1, further comprising printing resistance layers of the circuit by the print head in a single run.

6. The method according to claim 1, further comprising producing thicker resistance layers by printing a plurality of layers made of colloid ink mixtures.

7. The method according to claim 1, further comprising firing resistors after printing without subsequent trimming.

8. The method according to claim 1, further comprising, prior to being fed to the printing nozzles, heating the colloid inks in such a way that they become low-viscosity.

9. The method according to claim 1, further comprising:
imprinting the printed circuit traces by the printing of colloid ink using the print head; and
imprinting a resistor after a drying of the printed circuit traces.

10. The method according to claim 1, further comprising:
first drying the resistance layer; and
subsequently applying a cover layer.

11. The method according to claim 1, wherein the printing nozzles include at least one of piezoelectric nozzles, electrodynamic nozzles and bubble-jet nozzles.
